(19) United States
(12) Patent Application Publication
(10) Pub. No.: US 2026/0342834 A1
(43) Pub. Date: Oct. 29, 2026

(54) SECURITY RISK MANAGEMENT IN MULTI-TENANT ENVIRONMENTS USING SECRETS METADATA

(71) Applicant: NVIDIA Corporation, Santa Clara, CA (US)

(72) Inventors: Phani Bhushan AVADHANAM, San Diego, CA (US); Abhinav Chanda, Sunnyvale, CA (US)

(21) Appl. No.: 19/190,324

(22) Filed: Apr. 25, 2025

(51) Int. Cl. H04L 9/40

(52) U.S. Cl. CPC H04L 63/1433

(57) ABSTRACT

In various examples, systems and methods are disclosed related to facilitating identification of security risks using secrets metadata. In particular, secrets metadata associated with secrets stored in a secrets database may obtained and, thereafter, used to generate various security parameter data that indicate potential security risks. For example, quantity of secrets, shared secrets, non-compliant secrets, etc. may be indicative of a potential security risk in associated with a multi-tenant environment. Such security parameter data may be used to identify an extent of security risk, for example, by generating a security risk score. In some embodiments, a notification and/or remediation may be initiated or performed based on the security risk score (e.g., in cases in which a security risk score exceeds a threshold).

### BACKGROUND

Secrets management systems are used to securely store and manage sensitive information or secrets, such as database passwords, API keys, certificates, and authentication tokens. Such systems are generally designed to ensure that secrets are protected from unauthorized access and are used securely by applications and services, thereby preventing leaks and unauthorized access.

Secrets management systems oftentimes operate in multi-tenant environments. In particular, a secrets management system(s) may operate in a cloud or hybrid environment in which multiple tenants are supported. Such tenants are generally independent entities that run independent services in the multi-tenant environment. As such, security and isolation of each of the tenants is important. For example, data belonging to one tenant should not be accessible to another tenant, and vice versa.

Multiple tenants in a shared environment, however, may result in security breaches. For example, security breaches in a multi-tenant environment may occur due to vulnerabilities in tenant isolation, access control, shared infrastructure, and/or secrets management. As multiple tenants operate on a same platform, ineffective security measures can allow attackers to exploit misconfigurations and gain unauthorized access to sensitive data. As one example security risk, poor tenant isolation resulting from misconfigured access controls, flawed identity management, and/or insecure A Pls may allow one tenant to access another tenant's data. In this regard, logical separation may result in a vulnerability that can expose secrets, credentials, or sensitive information across multiple tenants.

As another example security risk, overly broad permissions and privilege escalation may present security risks. In cases in which a multi-tenant environment implements a group-based access model that provides unrestricted access to various groups, the likelihood of unauthorized users accessing secrets is increased. Additionally, insufficient role-based access control can allow users to gain access to secrets beyond their intended scope. For instance, an attacker that gains access to a low-privileged user account may be able to increase their access level due to poorly configured security settings, further expanding the impact of a breach.

Further, insufficient monitoring and incident response may further exacerbate security risks, as unauthorized access may go unnoticed for extended periods. Delayed incident response allows attackers more time to exploit vulnerabilities, potentially leading to widespread security incidents.

In conventional implementations, security risk assessment generally focuses on high-level infrastructure considerations. For example, conventional implementations may assess security risks based on transport layer security (TLS) configurations, endpoints, and/or vulnerability management solutions. Such conventional implementations, however, focus on specific security aspects (e.g., data encryption or access control) and fail to provide a holistic view of the security posture. Further, managing security across hybrid and cloud environments, and in particular multi-tenant environments, is oftentimes ineffective due to differing security models and policies utilized in association with different tenants and/or different infrastructures. As such, conventional implementations ineffectively performing risk assessment and managing multi-tenancy security in multi-tenant environments may result in various security breaches, compliance failures, and operational inefficiencies.

Moreover, conventional implementations of security risk assessments tend to rely on static evaluations that may not capture emerging threats in real time. In this regard, conventional secrets management solutions are often reactive rather than proactive. As a result, detecting security compromises is often delayed, increasing the time attackers have to exploit vulnerabilities and leaving organizations susceptible to security risks and inefficiencies.

In addition to increased security risks associated with conventional implementations of security risk assessments, implementation of such systems often results in inefficient use of computing resources. For example, as on-demand security patching may be more prominent with use of conventional implementations, unplanned updates across environments may increase compute cycles to deploy and verify patches. As another example, a reactive approach may result in ad-hoc forensic analysis, threat hunting, and deep packet inspection, all of which consuming high computing resources.

Accordingly, current approaches ineffectively identify security risks and/or create operational inefficiencies in association with multi-tenant environments. In this way, multi-tenant environments can become vulnerable to breaches, mismanagement, and exposure, thereby resulting in security risks to one or more tenants in association with a multi-tenant environment.

### SUMMARY

Embodiments of the present disclosure relate to security risk management in multi-tenant environments using secrets metadata. Systems and methods are disclosed that perform management of security risk identification in a proactive and holistic manner. In accordance with embodiments described herein, secrets metadata is obtained, for example, from a secrets data store and used to generate various security parameters that indicate or present security risks in accordance with secrets metadata. Such security parameter may then be used to determine an extent of security risk that may exist in association with a multi-tenant environment. In this regard, embodiments described herein enable automated detection of security risks in an efficient and effective manner across various multi-tenant environments. A proactive approach to continuously monitor and assess security posture to identify and mitigate risks results in a more effective multi-tenant environment.

In contrast to conventional implementations, facilitating identification of security risks in a multi-tenant environment using secrets metadata enables a more holistic and real-time approach to identifying risks in such environments. In addition to improved identification of security risks, security risks may be identified in a manner that enables proactive remediation to address any identified security risks. Further, computing resource utilization may be reduced as less resources may be needed to identify security risks in a centralized manner and to perform any necessary remediation when identified in advance of any impacts or spread of security issue across tenants.

### BRIEF DESCRIPTION OF THE DRAWINGS

The present systems and methods for security risk management for multi-tenant environments using secrets metadata are described in detail below with reference to the attached drawing figures, wherein:

FIG. 1 provides an example network environment, in accordance with some embodiments of the present disclosure;

FIG. 2 illustrates an example implementation for facilitating identification of security risks in association with multi-tenant environments using secrets metadata, in accordance with embodiments described herein;

FIG. 3 provides an example method for facilitating identification of security risks in association with multi-tenant environments using secrets metadata, in accordance with some embodiments of the present disclosure;

FIG. 4 provides an example method for facilitating identification of security risks in association with multi-tenant environments using secrets metadata, in accordance with some embodiments of the present disclosure;

FIG. 5 provides an example method for facilitating identification of security risks in association with multi-tenant environments using secrets metadata, in accordance with some embodiments of the present disclosure;

FIG. 6 is a block diagram of an example computing device suitable for use in implementing at least some embodiments of the present disclosure; and

FIG. 7 is a block diagram of an example data center suitable for use in implementing at least some embodiments of the present disclosure.

### DETAILED DESCRIPTION

Systems and methods are disclosed related to security risk management for a multi-tenant environment. In particular, security risks associated with a multi-tenant environment is managed or identified using metadata associated with secrets stored in a secrets management system. Stated differently, security posture for multi-tenant environments is managed using secrets metadata. Advantageously, using secrets metadata to identify a security posture associated with a multi-tenant environment provides a holistic and real-time approach for identifying security risk. In this regard, embodiments described herein enable automated detection of security risks in an efficient and effective manner across hybrid environments. A proactive approach to continuously monitor and assess security posture to identify and mitigate risks proactively results in a more effective multi-tenant environment.

In operation, to efficiently and effectively manage security risks, secrets metadata may be used to provide a holistic, comprehensive, and centralized approach for identifying security risks. As such, secrets metadata is obtained or referenced. Secrets metadata generally refers to structured information that describes or provides context to a secrets stored in a secrets data store. Such secrets may be API keys, database credentials, SSH keys, and/or the like. In some cases, secrets metadata may be obtained by communicating with a secret management system(s) to obtain secrets metadata associated with secrets, for example, in a multi-tenant environment. Secrets metadata may be obtained in association with any number of tenants within a multi-tenant environment.

In accordance with obtaining secrets metadata, security parameter data is identified using the secrets metadata. In this way, security parameter data represents or corresponds with one or more secrets of a multi-tenant environment. A security parameter generally refers to any parameter or attribute associated with a security risk corresponding with a multi-tenant environment. Examples of security parameters include an application number of secrets, a region number of secrets, a data center number of secrets, a tenant number of secrets, a number of expired secrets, a number of secrets to be rotated but not rotated within a time duration (e.g., 90 days), a number of secrets following policies associated with a secrets management system, a number of shared secrets across applications, a number of ongoing shared secrets, a number of one-time sharing secrets, a number of indication of whether multiple tenants can read the secrets of others, a number or indication of whether applications can be compromised to run as root. Security parameter data generally refers to a representation of data or values associated with a security parameter.

In some cases, the application number of secrets, region number of secrets, data center number of secrets, and tenant number of secrets security parameters may be considered a baseline factor in terms of identifying security risk. For example, applications having or associated with secrets may be considered a baseline factor, but not necessarily a high-risk indicator on its own. In embodiments, such secrets may be exclusive of one another. In this way, a particular secret may be one of an application secret, a region secret, a data center secret, or a tenant secret,

As described, additional security parameters may also be determined in association with the use or integrity of the secrets, such as a number of expired secrets, a number of secrets to be rotated but not rotated within a time duration (e.g., 90 days), a number of secrets following policies associated with a secrets management system, a number of shared secrets across applications, a number of ongoing shared secrets, a number of one-time sharing secrets, a number or indication of whether multiple tenants can read the secrets of others, a number of indication of whether applications can be compromised to run as root, and/or the like. Such security parameters may be associated with different levels or extent of security risks.

Using the security parameter data, a security risk score(s) may be generated in association with a multi-tenant environment, or a portion thereof. In this way, secret-related information can be used to assess security risks. A security risk score generally provides a value that represents a holistic view of security risks associated with the multi-tenant environment, or a portion thereof.

Security risk scores may be generated in any of a number of ways. As one example, security parameter data associated with a same risk weight may be aggregated or combined. In such a case, security parameters, and/or data associated therewith, may be assigned a risk weight. A risk weight assignment may be based on the criticalness or severity of the risk. As one example, the baseline security parameters, namely, the number of application secrets, the number of region secrets, the number of data center secrets, and the number of tenant secrets may be assigned a risk weight of 1. For the additional secrets related to integrity or hygiene, the number of one-time sharing parameter may also be assigned a risk weight of 1. Other security parameters may be assigned different risk weights depending on the severity of the risk. For instance, a number of shared secrets across applications, a number of ongoing shared secrets may be assigned a risk weight of 2. A number of expired secrets and a number of unrotated secrets may be assigned a risk weight of 3. A number or indicator of whether multiple tenants can read the secrets of others and a number or indicator of if applications can be compromised to run as root may be assigned a risk weight of 5. On the other hand, a number of secrets following the policies of secrets management may be assigned a risk weight of −2 as following policies reduces risk. Risk weights may be tunable or adjustable, for instance, in accordance with user preferences, data analysis, etc.

Accordingly, risk ratings based on risk weights may be determined. In this way, the various security parameter data associated with a same risk weight may be aggregated. For example, continuing with the assigned risk weights described above, a risk rating R1 for the security parameters having a risk weight of 1 may be R1=(S_{A}+S_{R}+S_{D}+S_{T}+OTS_{S}), where S_{A} denotes a number of application secrets, S_{R} denotes a number of region secrets, S_{D} denotes a number of data center secrets, S_{T} denotes number of tenant secrets, and OTS_{S} denotes a number of one-time shared secrets. A risk rating R2 for the security parameters having a risk weight of 2 may be R2=(2SH_{S}+2OS_{S}), where SH_{S} denotes a number of shared secrets across applications and OS_{S} denotes a number of ongoing secrets. A risk rating R3 for the security parameters having a risk weight of 3 may be R3=(3E_{S}+3NR_{S}), where E_{S} denotes a number of expired secrets and NR_{S} denotes unrotated secrets. A risk rating R4 for the security parameters having a risk weight of 5 may be R4=(5MT_{R}+5C_{R}), where MT_{R} represents a value of 1 or 0 indicating whether multiple tenants can read the secrets of others (e.g., 1 represents yes and 0 represents no) and C_{R} represents a value of 1 or 0 indicating whether an application(s) can be compromised to run as root (e.g., 1 represents yes and 0 represents no).

An overall security risk score indicating comprehensive risk may be generated. In embodiments, the various risk ratings are used to generate an overall security risk score in association with a multi-tenant environment, or portion thereof. One example for determining an overall security risk score includes an aggregation or summation of various risk weights over a total number of secrets. Such a number of may then be then multiplied by a linear scale of 100 to generate a comprehensive security risk score associated with the multi-tenant environment, or a portion thereof.

Security risk scores may be determined at any time. As one example, security risk scores may be generated at a predefined time or within a predefined time range (e.g., overnight hours, daily, etc.). As another example, security risk scores may be determined based on an occurrence of an event. For example, a security risk score(s) may be generated in accordance with commissioning an application, onboarding a tenant, upon remediation, migration of workloads from one data center to another data center, etc.

In accordance with generating security risks scores, such scores may be monitored, for example, to detect a potential issue to report or remediate. In some cases, a security risk score may be compared to a risk threshold to determine whether a potential security concern should be reported and/or remediated. Any number of risk thresholds may be established. By way of example, a security risk score falling below a first threshold may result in no action being taken. However, a security risk score between the first threshold and a second threshold may result in reporting, such as logging the issue, generating a warning, and/or flagging for manual review. Still further, a high-risk score exceeding the second threshold may trigger automated responses, such as secret rotation, access revocation, and/or applying necessary security patches.

Based on an extent of a security risk, for example, as determined via a comparison of a security risk score(s) and a risk threshold(s), an appropriate security response may be determined and/or initiated. In this way, alerts and/or remediation may be provided or initiated when potential security risks arise. In some cases, the particular response implemented or initiated may depend on the severity of the detected risk.

Various types of responses may be initiated or implemented. As one example, alerts or notifications may be initiated or implemented. Such warnings may be communicated to data center operators, application, owners, administrators, tenants, or the like when a potential security issue is detected. For example, in cases in which a tenant is operating in a high-risk manner, an alert may be issued to notify the appropriate personnel before further action is taken. As another example, remediation plans in relation to evaluation of security in association with onboarding new tenants and/or new applications may be determined or performed. By way of example only, in cases in which adding a new tenant would significantly increase the security risk score, onboarding might be prevented until certain conditions are met. Such evaluation of security risk scores may also influence infrastructure decisions, such as whether a tenant should be placed on a first platform or a second platform based on comparative security risk assessments. As another example, remediation workflows tailored to a particular issue may be initiated or implemented. For instance, in cases in which an application is using more secrets than necessary, a JIRA ticket may be communicated to a developer providing such details. In other cases, if an application is running in multiple regions but is using a single shared security, a recommendation or enforcement of secret rotation may be performed or each region may be required to use its own secret. In yet other cases, proper privilege management may be ensured or enforced. For instance, in cases in which it is detected that an application is running with root access, an automated workflow may be initiated to lower its privileges (e.g., by generating a policy update that requires approval from a developer or administrator before execution).

Advantageously, managing security risk of multi-tenant environments using data associated with secrets enables a comprehensive approach to proactively and timely identify security risks that exist or may be exposed. Further, such an automated implementation may facilitate real-time security risk detection, thereby improving responses to actual or potential security issues. In addition to improved security risk detection, computing resource utilization is reduced as less resources may be used in effectively identify security risks in an automated manner. For example, identifying potential security risks in advance may reduce computing resources that would otherwise be used to perform ad-hoc forensic analysis, deep packet inspection, increased workloads to isolate and contain threats that have spread across tenants, etc.

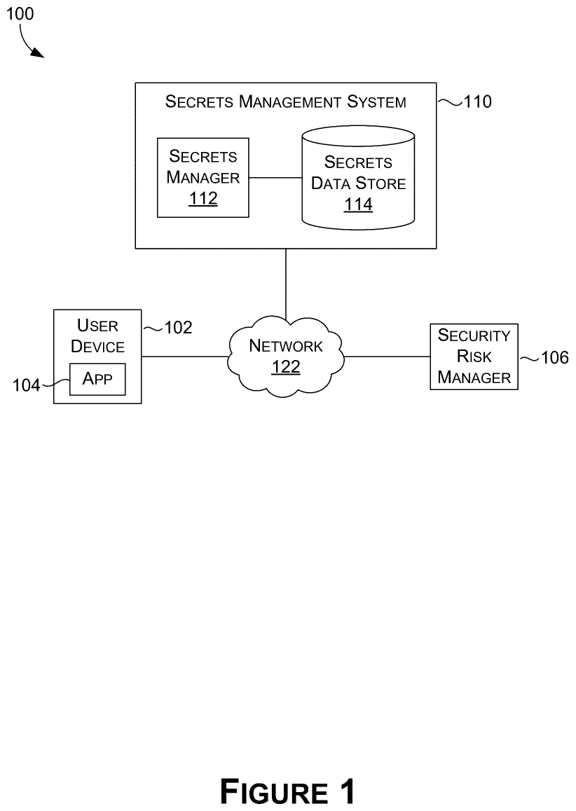

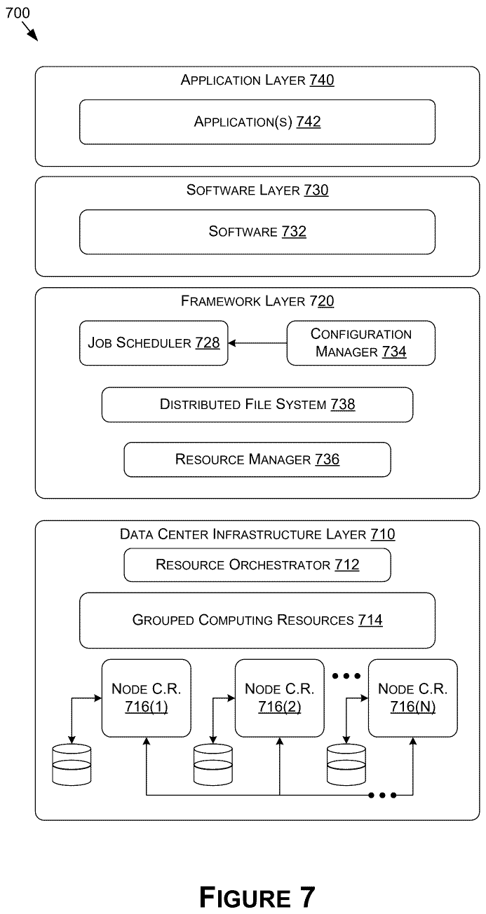

With reference to FIG. 1, FIG. 1 is an example network environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented one or more computing devices or components thereof (e.g., as described in FIG. 7), and/or one or more data centers or components thereof (e.g., as described in FIG. 8).

With continued reference to FIG. 1, a block diagram of an exemplary network environment 100 suitable for use in implementing embodiments described herein is shown. Generally, the system 100 illustrates an environment suitable for facilitating management of identification of security risks in association with multi-tenant environments using secrets metadata. Among other things, embodiments described herein effectively and efficiently manage security risk identification in an automated and holistic manner. In particular, such an environment is used to perform security risk identification and/or remediation thereof to facilitate an effective and secure multi-tenant environment.

The network environment 100 includes a user device 102, a security risk manager 106, and a secrets management system 110. The user device 102, the secrets issuer 106, and the secrets management system 110, can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. Further, although the environment 100 is illustrated with a network, one or more of the components may directly communicate with one another, for example, via HDMI (high-definition multimedia interface) and DVI (digital visual interface). Alternatively, one or more components may be integrated with one another. For example, at least a portion of the secrets management system 110 may be integrated with the user device 102. As another example, the security risk manager 106 may be integrated with the secrets management system 110.

The user device 102 can be any kind of computing device capable of facilitating identification of security risks in association with multi-tenant environments. For example, in an embodiment, the user device 102 can be a computing device such as computing device 700, as described above with reference to FIG. 7. In embodiments, the user device 102 can be a personal computer (PC), a laptop computer, a workstation, a mobile computing device, a personal digital assistant (PDA), a cell phone, or the like.

The user device 102 may include one or more processors and one or more computer-readable media. The computer-readable media may include computer-readable instructions executable by the one or more processors. The instructions may be embodied by one or more applications, such as application 104 shown in FIG. 1. The application(s) may generally be any application capable of facilitating use of secrets. In some implementations, the application(s) comprises a web application, which can run in a web browser, and could be hosted at least partially server-side. In addition, or instead, the application(s) may comprise a dedicated application. In some cases, the application is integrated into the operating system (e.g., as a service). Application 104 may be accessed via a mobile application, a web application, or the like.

User device 102 may be a client device on a client-side of operating environment 100, while security risk manager 106 and/or secrets management system 110 may be on a server-side of operating environment 100. Security risk manager 106 and/or secrets management system 110 may comprise server-side software designed to work in conjunction with client-side software on user device 102 so as to implement any combination of the features and functionalities discussed in the present disclosure. An example of such client-side software is application 104 on user device 102. This division of operating environment 100 is provided to illustrate one example of a suitable environment, and it is noted there is no requirement for each implementation that any combination of user device 102, security risk manager 106, and/or secrets management system 110 to remain as separate entities.

In an embodiment, the user device 102 is separate and distinct from the security risk manager 106 and the secrets management system 110 illustrated in FIG. 1. In another embodiment, the user device 102 is integrated with one or more illustrated components. For instance, the user device 102 may incorporate functionality described in relation to the secrets management system 110. For clarity of explanation, embodiments are described herein in which the user device 102, the security risk manager 106, and the secrets management system 110 are separate, while understanding that this may not be the case in various configurations contemplated.

A user device 102, as described herein, may be operated by an individual or set of individuals that desire to use a secret. In this regard, a user device 102 may request and use secrets, while interacting with the secrets management system 110. In operation, the user device 102, such as a laptop, mobile phone, server, or IoT device, may need to access to a secured resource, such as an API, database, or cloud service. To obtain the necessary credentials, the user device 102 may authenticates itself to a security issuer (e.g., an identity provider, certificate authority, or cloud service). Authentication may include multi-factor authentication (MFA), OAuth-based token exchanges, certificate validation, or federated identity verification using protocols, such as SAM L or OpenID Connect. Upon a successful authentication, the secret issuer may generate or assign a secret, such as an API key, JWT token, or encryption key, and securely delivers it to the user device 102 through an encrypted channel.

In accordance with receiving the secret at the user device 102, the user device 102 may use the secret. In embodiments, the user device 102 may initiate storage of the secret. In particular, in some cases, the user device 102 may initiate storage of the secret via the secrets management system 110, for example, for secure storage retrieval, and rotation of secrets, etc. For example, the user device 102 may interact with the secrets management system 110 to request secrets dynamically when needed. Upon receiving a request, the secrets manager 112 of the secrets management system 110 may verify the user device's authentication and authorization, retrieve the secret from the secrets data store 114, decrypts the secret in memory, and delivers the secret to the user device 102. Accordingly, the secrets remain centrally managed and protected, minimizing risks associated with static credentials stored directly on the device.

In addition, the user device 102 may communicate with the secrets management system 110 in relation to management of secrets. For example, the secrets management system may notify the user device 102 when a secret has been rotated. In some cases, the user device 102 may request the latest version based on the notification. User device interactions with the secrets management system may be logged and monitored for auditing, compliance, and security. By integrating with a secrets management system 110 (rather than handling secrets independently), the user device 102 may benefit from centralized security policies, automated secret lifecycle management, and enhanced protection against credential leaks and/or unauthorized access.

Although not shown, a secrets issuer generally generates and provisions secrets, such as API keys, encryption keys, authentication tokens, or credentials. As described, such secrets may be stored and managed within secrets management system 110. A secret issuer may be, for example, a cloud service provider, an internal identity management system, a certificate authority, a custom enterprise authentication service, or the like. As described, when a user device (such as a laptop, mobile phone, or server) requests access to a secured resource, it generally obtains a valid secret from the secret issuer. The device typically authenticates itself through multi-factor authentication, certificates, or federated identity protocols (e.g., OAuth, SAM L, or OpenID Connect). Once verified, the secret issuer generates or assigns a secret to the user device 102 and securely transmits it, often through an encrypted channel. Any number of secrets issuers may be used. For example, the user device (e.g., via app 104) may request a first secret from a first secrets issuer and a second secret from a second secrets issuer.

In embodiments, user device 102 may be associated with a tenant of a multi-tenant environment.

The secrets management system 110 is generally configured to securely manage and store secrets. In this regard, the secrets management system 110 may manage data, policies, access, rotation, creation, etc. of secrets. As described, when the user device 102 needs to use a secret (e.g., to access an API or decrypt sensitive data), it queries the secrets manager, which validates the request, retrieves the encrypted secret from the secrets data store, and securely delivers it to the device. Using the secrets management system, as described herein, enables secrets to remain secure, centrally managed, and accessible only to authorized devices and users while minimizing the risk of exposure or compromise.

A secrets management system 110 may include various components, including a secrets manager 112 and a secrets data store 114. At a high level, the secrets management system ensures that authorized users, applications, or services can retrieve secrets, while maintaining audit logs, automatic rotations, access enforcement, etc. to prevent unauthorized access and credential leaks. In embodiments, when a request for a secret is made, the secrets manager 112 may verify the requester's identity and permissions, retrieve a desired secret from the secrets data store 114, decrypts it, and securely delivers it to the requester. In some cases, the secrets management system may integrate with cloud services, DevOps pipelines, and/or container orchestration tools. Examples of secrets management systems include HashiCorp® Vault, AWS® Secrets Manager, Azure® Key Vault, and Google® Cloud Secret Manager, each offering different storage backends, access control mechanisms, and integrations. By implementing a robust secrets management system, organizations can reduce security risks, enforce least privilege access, and automate the lifecycle of credentials, ensuring that sensitive information remains protected against unauthorized access and breaches. Although illustrated as a secrets management system 110, in embodiments, multiple secrets management systems may be included in a networking environment.

The secrets manager 112 may be configured to orchestrate the secure storage, access, and lifecycle management of secrets, such as API keys, database passwords, encryption keys, and authentication tokens. As a central control layer, a secrets manager 112 provides policy enforcement, authentication, authorization, auditing, secret rotation, secret generation, etc. ensuring that only authorized users, applications, or services can access secrets when needed. It may not store secrets directly but interacts with a secrets data store 114, such as an encrypted secrets data store, where the actual secrets are securely persisted. In embodiments, the secrets manager 112 may facilitate role-based access control or identity-based access control, thereby ensuring that access to secrets is limited based on predefined security policies.

When an application or user requests access to a secret, the secrets manager 112 may authenticates the requester using credentials such as API tokens, OAuth identities, or cloud IAM roles. Once authenticated, the secrets manager 112 may checks the access control policies to determine whether the requester has the necessary permissions to retrieve the secret. If access is granted, the secrets manager retrieves the encrypted secret from the secrets data store, decrypts it in memory, and securely delivers it to the requesting application.

Additionally, the secrets manager 112 supports automatic secret rotation, which updates secrets at scheduled intervals or upon certain triggers (e.g., key expiration, security incidents, etc.). For example, if a database password is rotated, the secrets manager 112 updates the secrets data store 114, synchronizes the change with the database, and notifies authorized services (e.g., to initiate retrieval of the new version of the secret). In some cases, the secrets manager 112 may log access attempts, changes, and retrievals to maintain a detailed audit trail, ensuring compliance with security policies and regulatory requirements.

Examples of Secrets Managers include A W S® Secrets Manager, HashiCorp® Vault, Azure Key Vault®, and Google® Cloud Secret Manager, each providing various integrations with cloud services, Kubernetes, and DevOps pipelines. By acting as a mediator between applications and the secrets data store 114, a secrets manager helps organizations maintain centralized control, security, and automation over their sensitive secrets, preventing unauthorized access and reducing the risk of credential leaks.

In some cases, the functionality described herein, such as data management, policy management, rotation management, access management, and/or secret generation may be included directly in functionality provided by a secrets manager 112. In other cases, such functionality may be added to a secrets manager 112, for example, via a plugin. In this way, a plugin may be installed in association with a secrets manager to perform various secrets management functionality described herein. In some cases, a plugin may correspond with a particular type of secrets. In this regard, a particular plugin may be used for a particular type of secrets (e.g., Jenkins secrets). Accordingly, any number of plugins may be installed in association with a secrets manager 112.

In embodiments, the secrets manager 112 may manage any type of secrets. In this regard, assume a secrets manager 112 corresponds with a particular type of secrets (e.g., AWS secrets). In such a case, the secrets manager 112 may manage various types of secrets, in addition to the AWS secrets.

The secrets data store 114 generally refers to a secure backend storage component within the secrets management system 110. The secrets data store 114 may be responsible for persistently storing and encrypting sensitive credentials, such as API keys, database passwords, encryption keys, and authentication tokens. In embodiments, the secrets data store 114 is dedicated to protecting secrets, ensuring that they remain protected from unauthorized access or exposure. Secrets within the data store may be encrypted using strong cryptographic algorithms (such as AES-256) and may be further secured through Hardware Security Modules (HSMs), cloud-based Key Management Systems (KMS), or specialized storage backends like Consul, relational databases, object storage, or distributed key-value stores.

In embodiments, the secrets data store 114 may store additional data. For example, the secrets data store 114 may store secrets metadata, audit logs, etc. For example, when a credential needs to be updated (e.g., database password rotation), the secrets manager 112 may store audit logs of changes, accesses, and rotations, providing a history of how secrets have evolved over time.

The security risk manager 106 is generally configured is generally configured to manage security risk associated with a multi-tenant environment using metadata associated with secrets stored in a secrets management system, such as secrets management system 110. In particular, security risk manager 106 may manage security posture for multi-tenant environments using secrets metadata. Advantageously, and in accordance with embodiments described herein, using secrets metadata to identify a security posture associated with a multi-tenant cloud facilitates a holistic approach for identifying security risks. Although the security risk manager 106 is illustrated separate from the secrets management system 110, in some cases, the security risk manager 106 may be integrated or included with the secrets management system 110 (e.g., via an application, plugin, etc.), or a portion thereof.

In embodiments, the user device 102, the secrets management system 110, and/or the security risk manager 106 operate in a multi-tenant environment. A multi-tenant environment may refer to a system architecture where multiple tenants (e.g., users, organizations, or applications) share a common infrastructure (e.g., databases, computing resources, services) while maintaining logical isolation therebetween. In such environments, the tenants operating in the shared environment should only have access to its own data and configurations. Multiple tenants may exist across various deployment models, including public cloud environments, private (internal) data centers, and hybrid environments that combine both. In a public cloud, tenants share a provider-managed infrastructure with logical isolation mechanisms, such as virtual networks, IAM policies, and containerized workloads. In an internal data center, multi-tenancy is often implemented within an organization's private infrastructure using virtualization, Kubernetes namespaces, or segmented databases to support multiple departments or business units. Hybrid environments combine public and private resources, allowing tenants to operate across cloud and on-premises systems while maintaining secure access controls and data consistency.

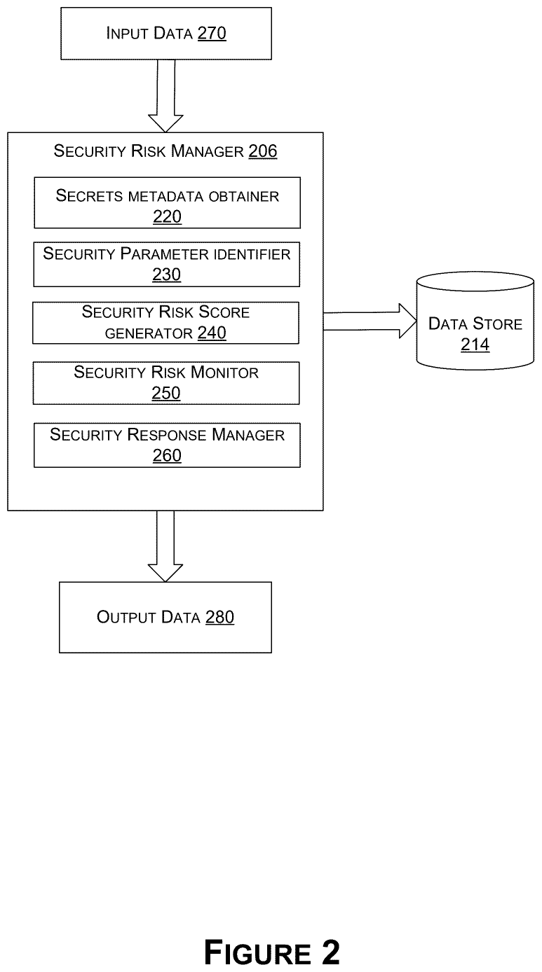

Turning now to FIG. 2, FIG. 2 illustrates an example implementation for facilitating effective management of security risk for a multi-tenant environment via security risk manager 206. In operation, the security risk manager 206 is generally configured to manage security risk associated with a multi-tenant environment using metadata associated with secrets stored in a secrets management system, such as secrets management system 110. In particular, security risk manager 206 may manage security posture for multi-tenant environments using secrets metadata. Advantageously, and in accordance with embodiments described herein, using secrets metadata to identify a security posture associated with a multi-tenant cloud facilitates a holistic approach for identifying security risks.

The security risk manager 206 may communicate with the data store 214. The data store 214 is configured to store data accessible by the security risk manager 206, or other server or component. In embodiments, the security risk manager 206, user devices (such as user device 102 of FIG. 1), a secrets issuer, etc., can provide data to the data store 214 for storage, which may be retrieved or referenced by any such component. As such, the data store 214 may store various types of data, such as secrets, secrets metadata, security parameters, security risk scores, security remediations, and/or the like. The data store 214 may persist data in a secure and encrypted manner. In some embodiments, the security risk manager 206 and/or the data store 214, may be part of a secrets management system. In other embodiments, the security risk manager 206 and/or the data store 214 may be separate and independent of the secrets management system (e.g., in a cloud environment).

As shown, in embodiments, input data 270 may be provided to the security risk manager 206. Various types of input data 270 may be input and may be input at various times. By way of example only, secrets metadata may be provided as input data 270 to the security risk manager 206 for use by the security risk manager 206. The security risk manager 206 may obtain various types of input data 270 and manage security risks in accordance therewith.

To effectively and efficiently manage security risk, in some embodiments, the security risk manager 206 includes a secrets metadata obtainer 220, a security parameter identifier 230, a security risk score generator 240, a security risk monitor 250, and a security response manager 260. According to embodiments described herein, the security risk manager 206 can include any number of other components not illustrated. In some embodiments, one or more of the illustrated components 220, 230, 240, 250, and 260 can be integrated into a single component or can be divided into a number of different components. Components 220, 230, 240, 250, and 260 can be implemented on any number of machines and can be integrated, as desired, with any number of other functionalities or services.

The secrets metadata obtainer 220 is generally configured to obtain metadata for secrets, also referred to herein as secrets metadata. Secrets metadata generally refers to data or contextual information about, or associated with, a secret(s). In this way, secrets metadata generally refers to structured information that describes or provides context to a secret(s) stored in a secrets data store, such as secrets data store 114 of FIG. 1 and/or data store 214. Secrets metadata may facilitate organizing, managing, and/or securing secrets. Examples of secrets metadata includes a secret name (e.g., identifier of a secret), a generation date (e.g., a date secret was generated), an expiration data (e.g., a TTL value indicating when the secret will expire or need rotation), an owner (e.g., individual or team responsible for secret), rotation data (e.g., secret to be rotated but not rotated within threshold), an access permission (e.g., information about who can view, edit, or delete a secret), a modification history (e.g., a log of changes made to the secret, including who made the changes and when), a usage statistic (e.g., data on how often and by whom the secret is accessed), a secret type (e.g., type of secret such as a password, API key, certificate, or token), policy data (e.g. secret following policy), shared secret data (e.g., indication of whether secret is shared, indication of who secret is shared with, etc.), an associated service(s) (e.g., services or applications that use the secret), whether the secret is to be used for an application(s) or human user(s), a secret issuer, a secret manager, etc.

In embodiments, secrets metadata may be obtained in a manner that preserves confidentiality of the corresponding secret. In particular, the secrets metadata obtainer 220 may identify secrets metadata without accessing the actual secrets values. As described, within a secrets data store, sensitive values such as API keys, database credentials, and SSH keys are stored. Without directly interacting with these values, the secrets metadata obtainer 220 can identify or extract metadata to determine various attributes such as the secret's issuer, manager (e.g., AWS® Secrets Manager, HashiCorp® Vault), intended use (e.g., for applications or human users), lifecycle policy (e.g., rotation frequency), etc.

The secrets metadata obtainer 220 may communicate with a secret management system(s) to obtain secrets metadata associated with secrets, for example, in a multi-tenant environment. In this regard, the secrets metadata obtainer 220 may communicate with a secrets manager and/or a secrets data store to obtain secrets metadata. As one example, the secrets metadata obtainer 220 may communicate with a secrets manager to request metadata. The secrets manager may then obtain secrets metadata from the secrets data store and provide the secrets metadata to the secrets metadata obtainer 220 as input data 270. As another example, the secrets metadata obtainer 220 may directly access the secrets data store and obtain secrets metadata.

Secrets metadata may be obtained in association with any number of tenants within a multi-tenant environment. In some cases, secrets metadata associated with each tenant in a multi-tenant environment may be obtained. For example, assume ten tenants are operating via a multi-tenant environment. In such a case, the secrets metadata obtainer 220 may obtain secrets metadata associated with various secrets corresponding with each of the ten tenants.

The secrets metadata obtainer 220 may obtain secrets metadata at any of a number of times. In some cases, secrets metadata may be obtained in a periodic manner. In this way, upon expiration of a time duration (e.g., one day), the secrets metadata obtainer 220 may obtain secrets metadata. In other cases, secrets metadata may be obtained in accordance with occurrence of an event. For instance, based on an indication or request to determine security risk in association with a multi-tenant environment, the secrets metadata obtainer 220 may obtain secrets metadata.

The security parameter identifier 230 is generally configured to identify security parameter data. A security parameter generally refers to any parameter or attribute associated with a security risk in association with a multi-tenant environment. Examples of security parameters include an application number of secrets, a region number of secrets, a data center number of secrets, a tenant number of secrets, a number of expired secrets, a number of secrets to be rotated but not rotated within a time duration (e.g., 90 days), a number of secrets following policies associated with a secrets management system, a number of shared secrets across applications, a number of ongoing shared secrets, a number of one-time sharing secrets, a number of indication of whether multiple tenants can read the secrets of others, a number or indication of whether applications can be compromised to run as root.

Security parameter data generally refers to a representation of data or values associated with a security parameter. In embodiments, the security parameter identifier 230 may use the secrets metadata to identify security parameter data. In this way, security parameter data represents or corresponds with one or more secrets of a multi-tenant environment. In some cases, the secrets metadata may include security parameter data such that the security parameter identifier 230 identifies such security parameter data therefrom. In other cases, the security parameter identifier 230 determines or derives security parameter data using the secrets metadata.

An application number of secrets generally refers to a number of secrets associated with a set of applications (e.g., of or used by one or more tenants of a multi-tenant environment). A secret associated with an application, also referred to as an application secret, may be any secret corresponding to a specific application. As such, an application secret may be independent of a region, data center, and/or tenant. In this regard, a secret corresponds with an application that may run in multiple regions, across multiple data centers and/or is not tenant-specific. Examples of application secrets include API keys for third-party services used by an application, database credentials for an application's backend, OAuth tokens for application authentication, etc.

In some cases, the application number of secrets may represent an average number of unique secrets in association with a set of applications or a number of secrets per application. For instance, assume three applications are used in a multi-tenant environment, with a first application associated with 5 secrets, a second application associated with 10 secrets, and a third application associated with 15 secrets. In such a case, the application number of secrets may be represented as 10 secrets per application. Alternatively or additionally, the application number of secrets may represent a total number of unique secrets across applications, for example, within a multi-tenant environment. For instance, continuing with the previous example of three applications within a multi-tenant environment, including a first application associated with 5 secrets, a second application associated with 10 secrets, and a third application associated with 15 secrets. In such a case, the application number of secrets may be represented as 30 secrets.

The region number of secrets generally refers to a number of secrets corresponding with a set of regions (e.g., of or used within a multi-tenant environment). A region may refer to geographical regions generally related to data center locations. In this way, a collection of data centers may be considered a region. A secret associated with a region, also referred to as a region secret, may be any secret corresponding to a region. As such, a region secret may be independent of an application, data center, and/or tenant. In this regard, a secret corresponds with a region that is not application specific, data center specific, or tenant specific. Region secrets may correspond to regional infrastructure components. Examples of region secrets include AWS IAM tokens for US West Infrastructure, Azure storage account keys for a Europe region, Encryption keys for data stored in a specific region, etc.

In some cases, the region number of secrets may represent an average number of unique secrets in association with a set of regions or a number of secrets per region. For instance, assume a multi-tenant environment includes four regions, with a first region associated with 10 secrets, a second region associated with 20 secrets, a third region associated with 30 secrets, and a fourth region associated with 40 secrets. In such a case, the region number of secrets may be represented as 25 secrets per region. Alternatively or additionally, the region number of secrets may represent a total number of unique secrets across regions, for example, within a multi-tenant environment. For instance, continuing with the previous example of four regions including a first region associated with 10 secrets, a second region associated with 20 secrets, a third application associated with 30 secrets, and a fourth region associated with 40 secrets. In such a case, the region number of secrets may be represented as 100 secrets.

The data center number of secrets generally refers to a number of secrets corresponding with a set of data centers (e.g., of or used within a multi-tenant environment). A secret associated with a data center, also referred to as a data center secret, may be any secret corresponding to a particular data center, such as a specific physical or cloud-based data center. As such, a data center secret may be independent of an application, a region, and/or tenant. In this regard, a secret corresponds with a data center that is not application, region, and/or tenant specific. Examples of data center secrets include internal database credentials for a particular on-premises data center, SSH private keys used to manage servers in a cloud data center, Kubernetes cluster secrets for a specific on-prem deployment, etc.

In some cases, the data center number of secrets may represent an average number of unique secrets in association with a set of data centers or a number of secrets per data center. For instance, a multi-tenant environment includes three data centers, with a first data center including 100 secrets, a second data center including 200 secrets, and a third data center including 300 secrets. In such a case, the data center number of secrets may be represented as 200 secrets per region. Alternatively or additionally, the data center number of secrets may represent a total number of unique secrets across regions, for example, within a multi-tenant environment. For instance, continuing with the previous example of three data centers within a multi-tenant environment, including a first data center associated with 100 secrets, a second data center associated with 200 secrets, and a third data center associated with 300 secrets. In such a case, the region number of secrets may be represented as 600 secrets.

The tenant number of secrets generally refers to a number of secrets associated with a set of tenants (e.g., of a multi-tenant environment). A secret associated with a tenant, also referred to as a tenant secret, may be any secret corresponding to a particular tenant. As such, a tenant secret may be independent of an application, data center, and/or region. In this regard, a secret corresponds with a tenant that is not application specific, data center specific, or region specific. A number of tenant secrets may include secrets across all workloads and services running in association with a particular tenant. Tenant secrets may include, for example, tenant-specific API keys for accessing shared services, unique encryption keys per tenant to protect customer data, separate database credentials for multi-tenant applications, etc.

In some cases, the tenant number of secrets may represent an average number of unique secrets in association with a set of tenants or a number of secrets per tenant. For instance, assume a multi-tenant environment includes four tenants, with a first tenant associated with 10 secrets, a second tenant associated with 10 secrets, a third tenant associated with 20 secrets, and a fourth tenant associated with 20 secrets. In such a case, the tenant number of secrets may be represented as 15 secrets per tenant. Alternatively or additionally, the tenant number of secrets may represent a total number of unique secrets across tenants, for example, within a multi-tenant environment. For instance, continuing with the previous example of four tenants, the tenant number of secrets may be represented as 60 secrets.

With regard to application number of secrets, region number of secrets, data center number of secrets, and tenant number of secrets, such security parameters may be considered a baseline factor in terms of identifying security risk. For example, applications having or associated with secrets may be considered a baseline factor, but not necessarily a high-risk indicator on its own. In embodiments, such secrets may be exclusive of one another. In this way, a particular secret may be one of an application secret, a region secret, a data center secret, or a tenant secret,

Additional security parameters may also be determined in association with the use or integrity of the secrets, such as a number of expired secrets, a number of secrets to be rotated but not rotated within a time duration (e.g., 90 days), a number of secrets following policies associated with a secrets management system, a number of shared secrets across applications, a number of ongoing shared secrets, a number of one-time sharing secrets, a number or indication of whether multiple tenants can read the secrets of others, a number of indication of whether applications can be compromised to run as root, and/or the like.

A number of expired secrets may refer to any number of secrets that have expired. A secret is generally expired when it has passed a predetermined validity period and, as such, is no longer usable, for example, for authentication, authorization, and/or encryption. An expired secret can pose a security risk for various reasons, such as continued use after expiration, lack of monitoring and alerting in association with expired secrets, etc.

A number of unrotated secrets may refer to any number of secrets to be rotated, but not rotated within a particular time duration, such as 90 days. For example, assume a rotation policy sets a time limit (e.g., 90 days) for secrets to be refreshed. If a secret has exceeded the time limit, it becomes stale and increases the security risk. Such unrotated secrets can create serious security vulnerabilities, increasing likelihood of unauthorized access, credential leaks, and privilege escalation.

A number of secrets following policies (e.g., policy compliant secrets) associated with a secrets management system may refer to any number of secrets that follow or comply with a policy(s). As described, a secrets management system may enforce policies to control how secrets are stored, accessed, rotated, etc. As such, a number of secrets that follow such policies may be a count of secrets that comply with one or more predefined rules for security, access control, expiration, rotation, and/or the like. Secrets that do not follow security policies, such as encryption, expiration, rotation, access control, or storage guidelines, pose serious risks by increasing the likelihood of unauthorized access, breaches, and operational failures.

A number of shared secrets across applications may refer to a count of secrets that are used by multiple applications, rather than being isolated to a single application. In this regard, a shared secret may be a secret multiple applications reuse for authentication, encryption, or access control. For example, a database password stored in a secrets manager accessed by a first application and a second application may be a secret shared across applications. Secrets may be shared across applications for various reasons. For example, a secret may be shared when microservices need access to the same database or API. As another example, a secret may be shared to reduce complexity in managing separate credentials per application. Shared secrets may indicate security risks. For instance, in cases in which one service that uses a shared secret is compromised, other applications that use that secret may be at risk.

A number of ongoing shared secrets refers to a number of secrets that are shared (e.g., continuously shared) across multiple applications, services, or tenants over an extended period of time. For example, a database password that is persistently used by multiple applications may be an ongoing shared secret. As another example, a cloud API key shared across multiple microservices on an ongoing basis may be an ongoing shared secret. Ongoing shared secrets may create a security risk if one of the applications is compromised.

A number of one-time sharing secrets may refer to secrets that are shared for a single-use scenario rather than being persistently shared. As one example, a one-time sharing secret may be a one-time access token generated for a user to authenticate with a third-party service. Although a one-time sharing secret may present security risks, such risks are lower as the secret expires after use.

A number or indication of whether multiple tenants can read the secrets of others may also provide an indication of a security risk, such as data breaches, privilege escalation, and compliance violations. For example, if a tenant(s) can read the secrets of another tenant(s), that is a critical security risk factor.

A number or indication of whether an application can be compromised to run as root may also be a security risk factor. In this way, it may be determined whether an application can be exploited in a way that allows the application to gain root (e.g., administrator) privileges, thereby allowing it to perform actions with the highest level of access on the system. As such, gaining root access enables an application to control an entire system, potentially leading to data theft or modification, system manipulation or destruction, installing malware or backdoors, escalating privileges for other attacks, etc.

In some cases, security parameter data may be identified in association with all secrets associated with a multi-tenant environment. In other cases, security parameter data may be identified in association with a portion of secrets associated with a multi-tenant environment. For example, secret parameter data may be identified in association with an analysis unit (e.g., a tenant(s), an application(s), a date center(s), a region(s), etc.). For instance, in cases in which a data center is being analyzed, a number of expired secrets may correspond with the data center being analyzed. As another example, in cases in which applications are generally being analyzed, a number of expired secrets may correspond with a set of applications.

In various implementations, any number of these security parameter data may be identified. Further, data may be identified in association with additional or different security parameters. The security parameters provided herein are merely illustrative of types of security parameters that may be identified.

The security risk score generator 240 is generally configured to generate security risk scores in association with a multi-tenant environment, or a portion thereof. A security risk score generally provides a value that represents a wholistic view of security risks associated with the multi-tenant environment, or a portion thereof. In embodiments, security risk scores are generated using security parameter data. In this way, secret-related information can be used to assess security risks.

Security risk scores may be generated in any of a number of ways. As one example, security parameter data associated with a same risk weight may be aggregated or combined. In such a case, security parameters may be assigned a risk weight. A risk weight assignment may be based on the criticalness or severity of the risk. As one example, the baseline security parameters, namely, the number of application secrets, the number of region secrets, the number of data center secrets, and the number of tenant secrets may be assigned a risk weight of 1. For the additional secrets related to integrity or hygiene, the number of one-time sharing parameter may also be assigned a risk weight of 1. Other security parameters may be assigned different risk weights depending on the severity of the risk. For instance, a number of shared secrets across applications, a number of ongoing shared secrets may be assigned a risk weight of 2. A number of expired secrets and a number of unrotated secrets may be assigned a risk weight of 3. A number or indicator of whether multiple tenants can read the secrets of others and a number or indicator of if applications can be compromised to run as root may be assigned a risk weight of 5. On the other hand, a number of secrets following the policies of secrets management may be assigned a risk weight of −2 as following policies reduces risk. Risk weights may be tunable or adjustable, for instance, in accordance with user preferences, data analysis, etc.

Accordingly, risk ratings based on risk weights may be determined. In this way, the various security parameters associated with a same risk weight may be aggregated. For example, continuing with the assigned risk weights described above, a risk rating R1 for the security parameters having a risk weight of 1 may be R1=(S_{A}+S_{R}+S_{D}+S_{T}+OTS_{S}), where S_{A} denotes a number of application secrets, S_{R} denotes a number of region secrets, S_{D} denotes a number of data center secrets, S_{T} denotes number of tenant secrets, and OTS_{S} denotes a number of one-time shared secrets. A risk rating R2 for the security parameters having a risk weight of 2 may be R2=(2SH_{S}+2OS_{S}), where SH_{S} denotes a number of shared secrets across applications and OS_{S} denotes a number of ongoing secrets. A risk rating R3 for the security parameters having a risk weight of 3 may be R3=(3E_{S}+3NR_{S}), where E_{S} denotes a number of expired secrets and NR_{S} denotes unrotated secrets. A risk rating R4 for the security parameters having a risk weight of 5 may be R4=(5MT_{R}+5C_{R}), where MT_{R} represents a value of 1 or 0 indicating whether multiple tenants can read the secrets of others (e.g., 1 represents yes and 0 represents no) and C_{R} represents a value of 1 or 0 indicating whether an application(s) can be compromised to run as root (e.g., 1 represents yes and 0 represents no).

An overall security risk score indicating comprehensive risk may be generated. In embodiments, the various risk ratings are used to generate an overall security risk score in association with a multi-tenant environment, or portion thereof. One example for determining an overall security risk score is as follows:

$$Security Risk Score = ( \frac{( R 1 + R 2 + R 3 + R 4 - 2. {P}_{S} )}{( {T}_{S} )} ) * 100$$

In this example, P_{S} represents the number of secrets that follow policies. As shown, the negative weight of 2 is multiplied with the number of secrets that follow policies to reduce the risk rating. The summation of R1, R2, R3, R4, and P_{S} is divided by the total number of secrets, T_{S}, which is then multiplied by a linear scale of 100.

By way of example only, and using the security parameters described herein, assume the security parameter data is as follows:
Number of secrets per application (S_{A}): 50
Number of secrets per region (S_{R}): 30
Number of secrets per data center (S_{D}): 20
Number of secrets per tenant (S_{T}): 40
Number of expired secrets (E_{S}): 10
Number of secrets to be rotated but not rotated within 90 days (NR_{S}): 15
Number of secrets following the policies of secrets management (P_{S}): 80
Number of shared secrets across applications (SH_{S}): 5
Number of ongoing sharing secrets (OS_{S}): 3
Number of one-time sharing secrets (OTS_{S}): 2
Indicator if multiple tenants can read the secrets of others (MT_{R}): 1 (yes)
Indicator if applications can be compromised to run as root (C_{R}): 0 (no)
Total Number of Secrets (T_{S}):

In this example, the total number of secrets, T_{S}, is determined to be S_{A}+S_{R}+S_{D}+S_{T}=50+30+20+40=140. Applying the formulas provided above,

R1=50+30+20+40+2=142

R2=2*5+2*3=16

R3=3*10+3*15=75

R4=5*1+5*0=5

Further, for the security risk rating, the numerator is determined to be 78 (i.e., 142+16+75+5−2*80=78), and the denominator is determined to be 140, as described above. As such, the security risk rating is 55.71 (i.e., (78/140)*100). Such a security risk rating of 55.71 for a multi-tenant environment represents a moderate level of security risk. As can be appreciated, the weights and/or security parameters may be adjusted to reflect specific context and priorities of a multi-tenant environment.

The security risk score generator 240 may determine security risk scores at any time. As one example, security risk scores may be generated at a predefined time or within a predefined time range (e.g., overnight hours, daily, etc.). As another example, security risk scores may be determined based on an occurrence of an event. For example, a security risk score(s) may be generated in accordance with commissioning an application, onboarding a tenant, upon remediation, migration of workloads from one data center to another data center, etc.

The security risk monitor 250 is generally configured to monitor security risk scores and detect a potential issue to report or remediate. In this regard, the security risk monitor 250 may monitor security risk scores generated via the security risk score generator 240. In some cases, the security risk monitor 250 may compare security risk scores to a risk threshold to determine whether a potential security concern should be reported and/or remediated. A risk threshold may be defined in any of a number of ways. As one example, a risk threshold may be a user-specified threshold. As another example, a risk threshold may be a predefined or default threshold, for example, implemented or established by the security risk manager 206. In yet another example, a risk threshold may be dynamically determined based on, for example, real-time security conditions, historical data, contextual risk assessments, etc. In some cases, a risk threshold may be a particular value (e.g., 50). In other cases, a risk threshold may be an increase amount (e.g., a security risk score increased by more than a value of 10 since the last security risk score was generated). this can detect whether issue to report or mediate.

Further, any number of risk thresholds may be established. By way of example, a security risk score falling below a first threshold may result in no action being taken. However, a security risk score between the first threshold and a second threshold may result in reporting, such as logging the issue, generating a warning, and/or flagging for manual review. Still further, a high-risk score exceeding the second threshold may trigger automated responses, such as secret rotation, access revocation, and/or applying necessary security patches.

The security response manager 260 is generally configured to manage security responses, for example, in cases in which the security risk monitor 250 detects a potential security risk. In this way, a security response manager 260 may provide or initiate alerts and/or remediation when potential security risks arise. In some cases, the particular response implemented or initiated may depend on the severity of the detected risk.

Various types of responses may be initiated or implemented by the security response manager 260. As one example, the security response manager 260 may initiate or implement alerts or notifications as output data 280. Such warnings may be communicated to data center operators, application, owners, administrators, tenants, or the like when a potential security issue is detected. For example, in cases in which a tenant is operating in a high-risk manner, an alert may be issued to notify the appropriate personnel before further action is taken.

As another example, the security response manager 260 may facilitate evaluation of security in association with onboarding new tenants and/or new applications. By way of example only, in cases in which adding a new tenant would significantly increase the security risk score, onboarding might be prevented until certain conditions are met. Such a process may ensure that all tenants operate in a low-risk environment, even when no malicious actors are present. Such evaluation of security risk scores may also influence infrastructure decisions, such as whether a tenant should be placed on a first platform or a second platform based on comparative security risk assessments. Such alerts, notifications, and/or assessments may be provided as output data 280 and presented via any communication system, such as electronic mail, a dashboard, etc.

As another example, the security response manager 260 may initiate or implement remediation workflows tailored to a particular issue. For instance, in cases in which an application is using more secrets than necessary, a JIRA ticket may be communicated to a developer providing such details. In other cases, if an application is running in multiple regions but is using a single shared security, a recommendation or enforcement of secret rotation may be performed or each region may be required to use its own secret. In yet other cases, proper privilege management may be ensured or enforced. For instance, in cases in which it is detected that an application is running with root access, an automated workflow may be initiated to lower its privileges (e.g., by generating a policy update that requires approval from a developer or administrator before execution).

As such, the security response manager 260 may provide, as output data 280, various types of alerts, notifications, assessments, remediation instructions, or other security response data. In some cases, such output data 280 may be provided to a data store, such as data store 214. As another example, output data 280 may be provided to a user device or other server (e.g., to a requestor of such information or analysis, or to an entity associated with an impacted tenant, application, data center, etc.).

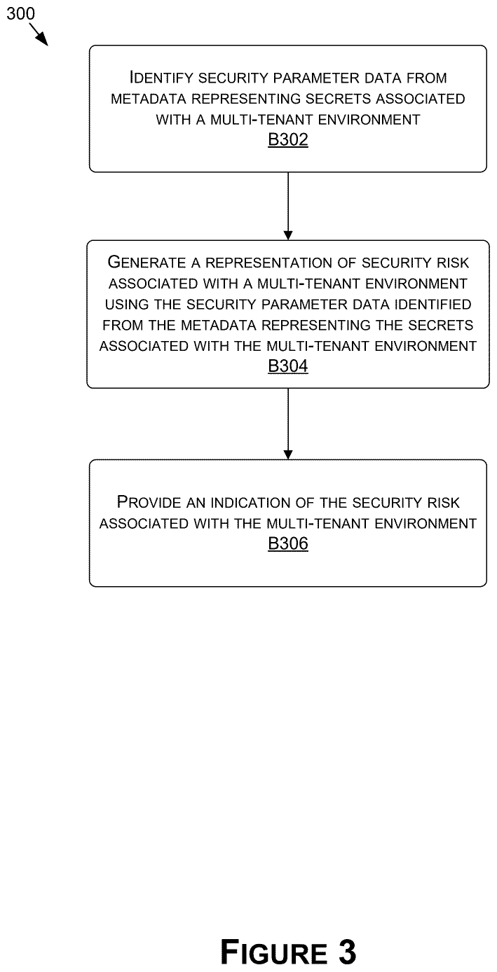

Now referring to FIGS. 3-5, each block of methods 300, 400, and 500 described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, methods 300, 400, and 500 are described, by way of example, with respect to the system of FIG. 1 and FIG. 2. However, this method may additionally or alternatively be executed by any one system, or any combination of systems, including, but not limited to, those described herein.

FIG. 3 is a flow diagram showing a method 300 for facilitating identification of security risks in association with a multi-tenant environment using secrets metadata, in accordance with some embodiments of the present disclosure. The method 300, at block B 302, includes identifying security parameter data from metadata representing secrets associated with a multi-tenant environment. In embodiments, the metadata representing secrets is obtained from a secrets data store of a secrets management system. The security parameter data may be any type of data representing secrets, such as, for example an application number of secrets, a region number of secrets, a data center number of secrets, a tenant number of secrets, a number of expired secrets, a number of unrotated secrets, a number of secrets following one or more policies, a number of shared secrets across applications, a number of ongoing shared secrets, a number of one-time shared secrets, an indication of whether multiple tenants can read one or more secrets of others, an indication of whether one or more applications can be compromised to run as root, and/or the like.

The method 300, at block B 304, includes generating a representation of security risk associated with a multi-tenant environment using the security parameter data identified from the metadata representing the secrets associated with the multi-tenant environment. In some cases, the representation of security risk comprises a security risk score that is generated by aggregating a plurality of weighted security parameter data. Such an aggregation of weighted security parameter data may be relative to a total number of secrets.

The method 300, at block B 306, includes providing an indication of the security risk associated with the multi-tenant environment. In some cases, the multi-tenant environment includes a secret management system that manages secrets associated with multiple tenants. An indication of a security risk may be provided in any number of forms. As one example, an indication of the security risk may be a notification of the representation of the security risk. In some cases, a remediation workflow corresponding with the indication of the security risk may be initiated in an effort to overcome or avoid a potential security issue(s).

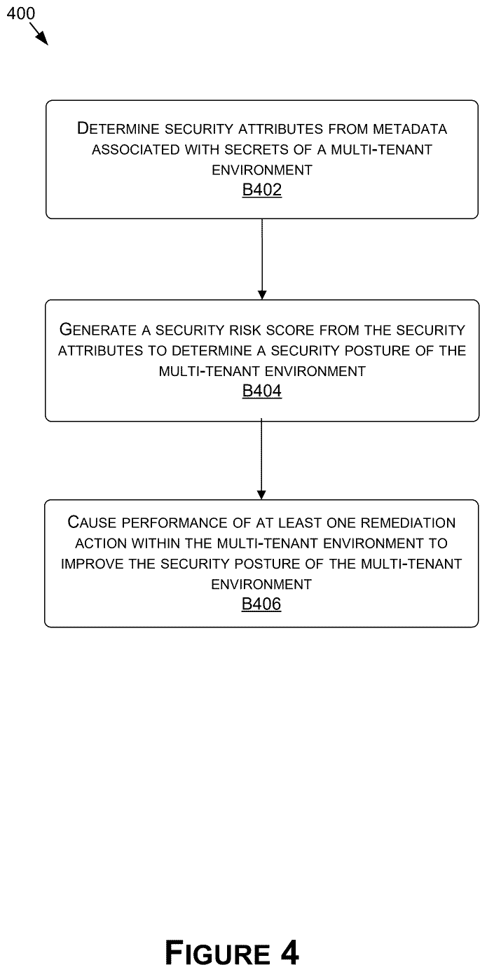

FIG. 4 provides a flow diagram showing a method 400 for facilitating identification of security risks in association with a multi-tenant environment using secrets metadata, in accordance with some embodiments of the present disclosure. The method 400, at block B 402, includes determining security attributes from metadata associated with a multi-tenant environment. Such secret attributes may be one or more of an application number of secrets, a region number of secrets, a data center number of secrets, a tenant number of secrets, a number of expired secrets, a number of unrotated secrets, a number of secrets following one or more policies, a number of shared secrets across applications, a number of ongoing shared secrets, a number of one-time shared secrets, an indication of whether multiple tenants can read one or more secrets of others, an indication of whether one or more applications can be compromised to run as root, among other things. The secrets can correspond with multiple tenants of the multi-tenant environment.

The method 400, at block B 404, includes generating a security risk score from the security attributes to determine a security posture of the multi-tenant environment. In some cases, the security risk score indicates an extent of security risk associated with the multi-tenant environment. The security risk score may be compared with a risk threshold value to determine, for example, whether to generate a notification associated with the extent of the security risk or to initiate a remediation workflow corresponding with the extent of the security risk.

The method 400, at block B 406, includes causing performance of at least one remediation action within the multi-tenant environment to improve the security posture of the multi-tenant environment.

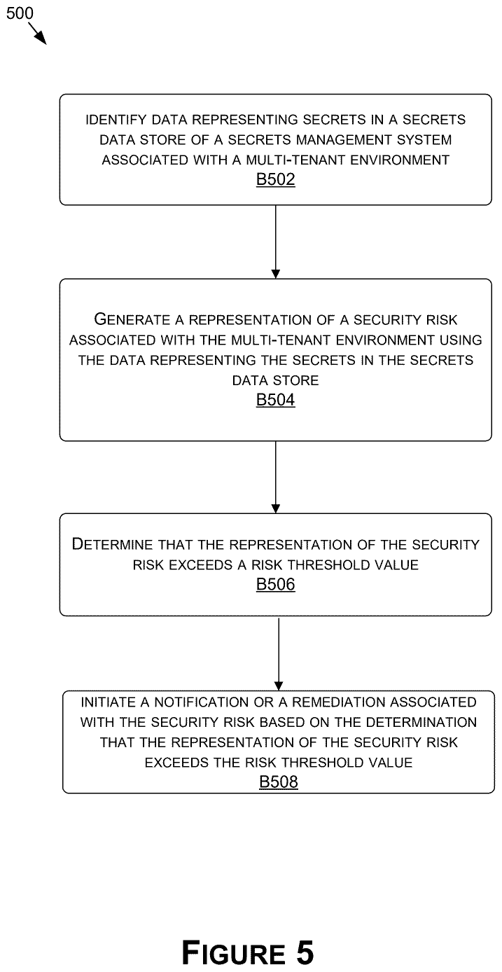

Turning to FIG. 5, FIG. 5 provides a flow diagram showing a method 500 for facilitating identification of security risks in association with a multi-tenant environment using secrets metadata. The method 500, at block B 502, includes identifying data representing secrets in a secrets data store of a secrets management system associated with a multi-tenant environment. In embodiments, the data representing secrets may be one or more of an application number of secrets, a region number of secrets, a data center number of secrets, a tenant number of secrets, a number of expired secrets, a number of unrotated secrets, a number of secrets following one or more policies, a number of shared secrets across applications, a number of ongoing shared secrets, a number of one-time shared secrets, an indication of whether multiple tenants can read one or more secrets of others, an indication of whether one or more applications can be compromised to run as root, among other things.

The method 500, at block B 504, includes generating a representation of a security risk associated with the multi-tenant environment using the data representing the secrets in the secrets data store. In one example, generating the representation of the security risk may include applying weights to the data representing the secrets and using the weighted data to generate a security risk score that indicates an extent of risk associated with security of the multi-tenant environment.

The method 500, at block B 506, includes determining that the representation of the security risk exceeds a risk threshold value. Such a risk threshold value may be predefined or established, for example, by an administrator.

The method 500, at block B 508, includes initiating a notification or a remediation associated with the security risk based on the determination that the representation of the security risk exceeds the risk threshold value. In some cases, a notification or an indication of the remediation may be displayed via a user device.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some embodiments, the system and methods described herein may be deployed in a talking or smart kiosk application. For example, a kiosk, tablet, smart display, or other device may include one or more onboard processors (e.g., CPUs, GPU s, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, SLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, SLMs, VLMs, M MLM s, etc.), DNNs, etc.) to enhance gameplay, generate real-time dynamic content, aid in collaboration or team efforts among teams, and/or personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/M R/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DM A) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, SLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

### Example Computing Device

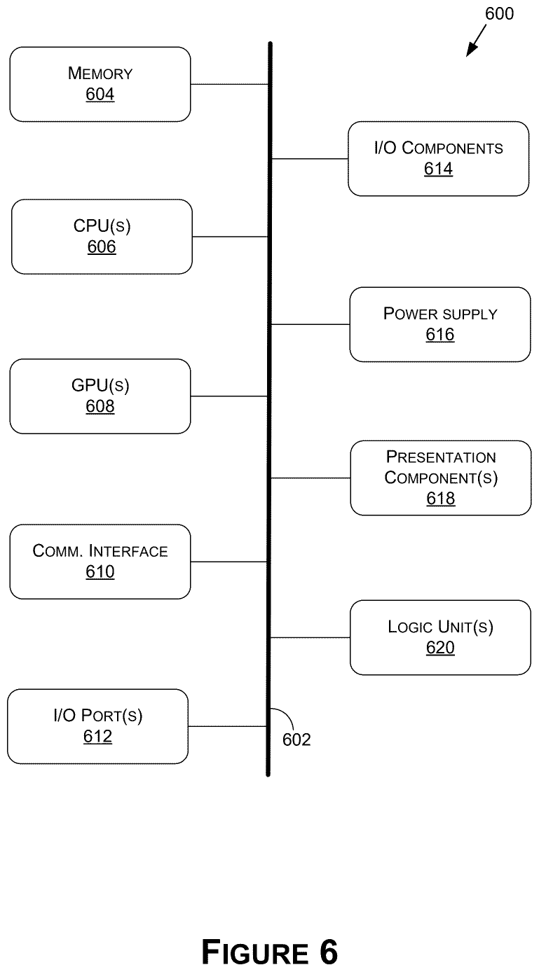

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (V ESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NV Switch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PV Cs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DM A) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IM U)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (A Pls)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
identify security parameter data from metadata representing secrets associated with a multi-tenant environment;
generate a representation of security risk associated with a multi-tenant environment using the security parameter data identified from the metadata representing the secrets associated with the multi-tenant environment; and
provide an indication of the security risk associated with the multi-tenant environment.

2. The one or more processors of claim 1, wherein the processing circuitry is further configured to obtain the metadata representing secrets from a secrets data store of a secrets management system.

3. The one or more processors of claim 1, wherein the security parameter data represents one or more of an application number of secrets, a region number of secrets, a data center number of secrets, or a tenant number of secrets.

4. The one or more processors of claim 1, wherein the security parameter data represents one or more of a number of expired secrets, a number of unrotated secrets, a number of secrets following one or more policies, a number of shared secrets across applications, a number of ongoing shared secrets, a number of one-time shared secrets, an indication of whether multiple tenants can read one or more secrets of others, or an indication of whether one or more applications can be compromised to run as root.

5. The one or more processors of claim 1, wherein generating the representation of security risk comprises generating a security risk score that aggregates a plurality of weighted security parameter data.

6. The one or more processors of claim 1, wherein the representation of security risk comprises a security risk score based on an aggregation of a plurality of weighted security parameter data relative to a total number of secrets.

7. The one or more processors of claim 1, wherein the multi-tenant environment includes a secret management system that manages secrets associated with multiple tenants.

8. The one or more processors of claim 1, wherein the indication of the security risk comprises a notification of the representation of the security risk.

9. The one or more processors of claim 1, wherein the processing circuitry is further configured to initiate a remediation workflow corresponding with the indication of the security risk.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

11. A system comprising one or more processors to:
determine security attributes from metadata associated with secrets of a multi-tenant environment;
generate a security risk score from the security attributes to determine a security posture of the muti-tenant environment; and
based on the security risk score, cause performance of at least one remediation action within the multi-tenant environment to improve the security posture of the multi-tenant environment.

12. The system of claim 11, wherein the security attributes comprise one or more of an application number of secrets, a region number of secrets, a data center number of secrets, a tenant number of secrets, a number of expired secrets, a number of unrotated secrets, a number of secrets following one or more policies, a number of shared secrets across applications, a number of ongoing shared secrets, a number of one-time shared secrets, an indication of whether multiple tenants can read one or more secrets of others, or an indication of whether one or more applications can be compromised to run as root.

13. The system of claim 11, wherein the secrets correspond with multiple tenants of the multi-tenant environment.

14. The system of claim 11, wherein the security risk score indicates an extent of security risk associated with the multi-tenant environment, and the security risk score is compared with a risk threshold value to determine whether to generate a notification associated with the extent of the security risk or to initiate a remediation workflow corresponding with the extent of the security risk.

15. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

16. A method comprising:
identifying security parameter data representing secrets within a multi-tenant environment without accessing the secrets;
generating a representation of a security risk associated with the multi-tenant environment using the security parameter data representing the secrets; and
initiating a notification or a remediation associated with the security risk based on the representation of the security risk.

17. The method of claim 16, wherein the security parameter data representing secrets comprises one or more of an application number of secrets, a region number of secrets, a data center number of secrets, a tenant number of secrets, a number of expired secrets, a number of unrotated secrets, a number of secrets following one or more policies, a number of shared secrets across applications, a number of ongoing shared secrets, a number of one-time shared secrets, an indication of whether multiple tenants can read one or more secrets of others, or an indication of whether one or more applications can be compromised to run as root.

18. The method of claim 16, wherein generating the representation of the security risk comprises:
applying weights to the security parameter data representing the secrets; and
using the weighted data to generate a security risk score that indicates an extent of risk associated with security of the multi-tenant environment.

19. The method of claim 16 further comprising causing display of the notification or an indication of the remediation.

20. The method of claim 16, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.
